(19) United States
(12) Patent Application Publication
(10) Pub. No.: US 2008/0093035 A1
(43) Pub. Date: Apr. 24, 2008

(54) Windows blinds

(76) Inventors: Sheng Ying Hsu, Fuxing Shiang (TW); Wu Chung Nien, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/510,811

(22) Filed: Aug. 28, 2006

(51) Int. Cl. E06B 9/303

(52) U.S. Cl. 160/176.1 R

(57) ABSTRACT

A window blinds includes a head box and a series of slats connected under the head box. An operating system is received in the head box. The operating system having a shaft rotatably and movably disposed in the head box. A first operating cord and a second operating cord respectively have a first end coiled on the shaft and a second end sequentially extending through the head box and the series of slats for adjusting a height of the slats. An adjusting device is mounted in the head box. The adjusting device includes a polygonal shaft disposed in the head box. Two adjusting cords respectively are connected to the polygonal shaft and have two opposite ends respectively sequentially connected to two opposite sides of each of the series of slats for adjusting an angle of each of the series of slats.

### BACKGROUND OF THE INVENTION

1. Field of the Invention

The present invention relates to window covering systems, and more particularly to a horizontal window blinds.

2. Description of Related Art

Windows covering systems exist primarily to shield interior spaces from direct sunlight and to prevent others from viewing inside through the window.

A conventional window blinds usually comprises a seat and a shaft pivotally mounted in the seat. The shaft has an annular groove defined in a first end thereof. A drive axle longitudinally and centrally extends through the shaft and connected with the shaft for driving the shaft. A loop is received in the annular groove in the shaft. The loop has a spiral groove defined in an outer periphery thereof and connected to two opposite ends of the loop. A cord has one end fixed on a second end of the shaft for raising/lowering the slats of the window blinds. Two adjusting cords respectively fixed to the two opposite ends of the loop. As a result, the slats are raised/lowered when the shaft is continually rotated to roll/release the cord, and the slats is adjusted when the loop clamps the shaft and rotated with the shaft to roll the two adjusting cords.

The shaft, the loop and the drive axle are concentrically assembled to one another for raising/lowering or adjusting the slats. However, to concentrically operate the shaft, the loop and the drive axle for raising/lowering or adjusting is complicated for a user.

The present invention has arisen to mitigate and/or obviate the disadvantages of the conventional window blinds.

### SUMMARY OF THE INVENTION

The main objective of the present invention is to provide an improved window blinds that has a simplified structure and can be easily operated.

To achieve the objective, window blinds in accordance with the present invention comprises a head box and a series of slats connected under the head box. An operating system is received in the head box. The operating system has a shaft rotatably and movably disposed in the head box. A first operating cord and a second operating cord respectively have a first end coiled on the shaft and a second end sequentially extending through a bottom of the head box and the series of slats. A drive device with a spring is mounted in the head box. A drive cord has a first end coiled on the shaft and a second end connected to the spring for driving the shaft. An adjusting device is mounted in the head box. The adjusting device includes an adjusting driver mounted in the head box opposite to the drive device and a polygonal shaft with one end connected to the adjusting driver. A first adjusting cord has a middle portion connected to the polygonal shaft and two opposite ends respectively extending through the bottom of the head box and sequentially connected to two opposite sides of each of the series of slats for adjusting an angle of each of the series of slats when the polygonal shaft is rotated. A second adjusting cord has a middle portion connected to the polygonal shaft and two opposite ends respectively extending through the bottom of the head box and sequentially connected to two opposite sides of each of the series of slats for adjusting an angle of each of the series of slats when the polygonal shaft is rotated. The adjusting device has a wheel laterally mounted thereon. An adjusting rope is wound the wheel and extends through the bottom of the head box for user to operate the adjusting drive for rotating the polygonal shaft.

Further benefits and advantages of the present invention will become apparent after a careful reading of the detailed description with appropriate reference to the accompanying drawings.

### BRIEF DESCRIPTION OF THE DRAWINGS

FIG. 1 is a partial perspective view of a window blinds in accordance with the present invention;

FIG. 2 is an exploded perspective view of the structures in FIG. 1;

FIG. 3 is a perspective view of a window blinds in accordance with the present invention;

FIG. 4 is a first operational view of the window blinds of the present invention when raising slats;

FIG. 5 is a second operational view of the window blinds of the present invention when raising slats;

FIG. 6 is a third operational view of the window blinds of the present invention when raising slats;

FIG. 7 is a first operational view of the window blinds of the present invention when adjusting slats; and

FIG. 8 is a second operational view of the window blinds of the present invention when adjusting slats.

### DETAILED DESCRIPTION OF THE INVENTION

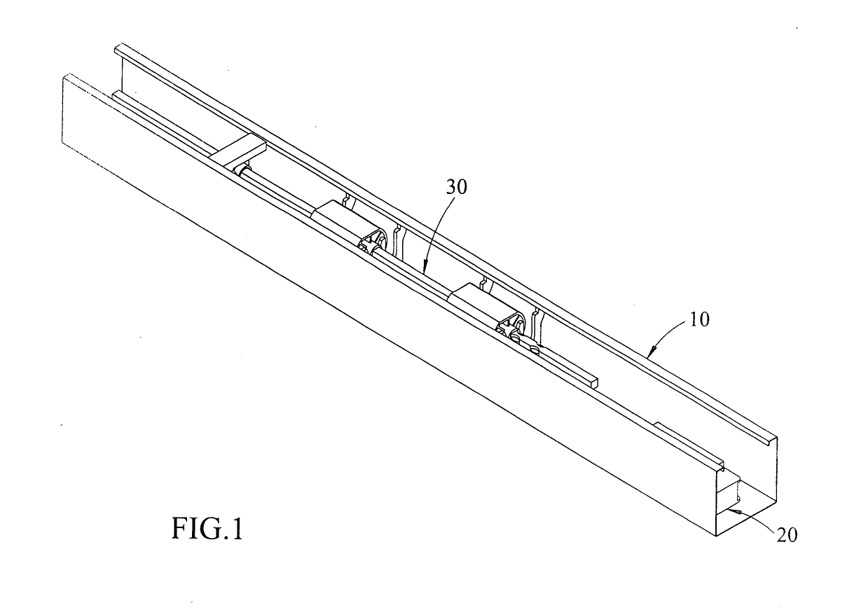

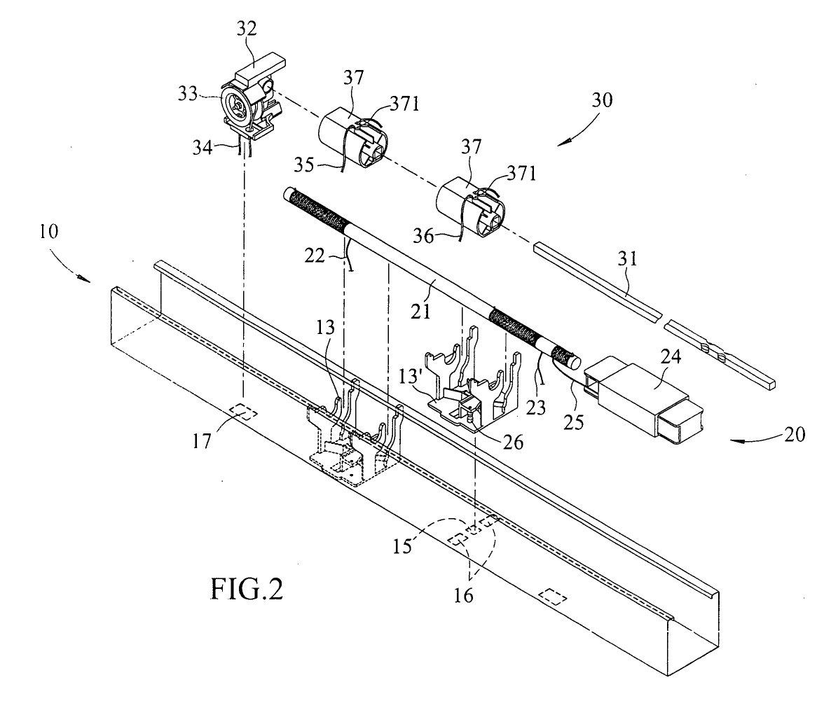

Referring to the drawings and initially to FIGS. 1-3, a window blinds in accordance with the present invention comprises a head box (10), an operating system (20) mounted in the head box (10) and an adjusting device (30) mounted in the head box (10).

The head box (10) has a chamber (11) longitudinally defined therein for receiving the operating system (20) and the adjusting device (30). A series of slats (12) are connected under the head box (10). A first frame (13) and a second frame (13′) are respectively mounted to a bottom of the head box (10) in interval. A lower bar (14) is used as the lowest slat (12) for user to raise/lower the slats (12).

The operating system (20) includes a shaft (21) rotatably and movably extending through a lower portion of each of the first and second frames (13, 13′). A first operating cord (22) has a first end coiled on the shaft (21) and a second end downwardly extending through the head box (10) and the series of slats (12). Lastly, the second end of the first operating cord (22) is secured on a bottom of the lower bar (14). A second operating cord (23) has a first end coiled on the shaft (21) and a second end downwardly extending through the head box (10) and the series of slats (12). Lastly, the second end of the second operating cord (23) is secured on a bottom of the lower bar (14). The second frame (13′) has a roller (26) mounted thereon. A drive device (24) with a spring (not numbered) is disposed in the head box (10) and corresponds to the second frame (13′). A drive cord (25) has a first end sequentially winding the roller (26) and coiled on the shaft (21), and a second connected to the spring in the drive device (24).

The adjusting device (30) includes a adjusting driver (32) mounted in the head box (10) opposite to the drive device (24) and two drive seats (37) respectively rotatably mounted on a top portion of a corresponding one of the two frames (13, 13′). A polygonal shaft (31) longitudinally extends through the two drive seats (37) and engaged to the adjusting driver (32). The adjusting driver (32) has a wheel (33) laterally mounted thereon. An adjusting rope (34) is wound the wheel (33) and extending through the bottom of the head box (10) for user to drive the adjusting driver (32). Each drive sear (37) has a connector (371) formed thereon. A first adjusting cord (35) extends through a corresponding one of the two drive seats (37) and has a middle portion connected to the connector (371) of the corresponding one of the two drive seats (37). The first adjusting cord (35) has two opposite ends respectively extending the bottom of the head box (10) and sequentially connected to two opposite sides of each of the series of slats (12) and the lower bar (14) for adjusting the angle of the series of slats (12). A second adjusting cord (36) extends through a corresponding one of the two drive seats (37) and has a middle portion connected to the connector (371) of the corresponding one of the two drive seats (37). The second adjusting cord (36) has two opposite ends respectively extending the bottom of the head box (10) and sequentially connected to two opposite sides of each of the series of slats (12) and the lower bar (14) for adjusting the angle of the series of slats (12).

The head box (10) has two first through hole (15) defined in the bottom thereof to allow the first operating cord (22) and the second operating cord (23) extending the bottom of the head box (10). The head box (10) has multiple second through holes (16) defined in the bottom thereof to allow the opposite ends of the first adjusting cord (35) and the second adjusting cord (36) extending through the bottom of the head box (10). The head box (10) has a third through hole (17) defined in the bottom thereof to allow the adjusting rope (34) extending through the bottom of the head box (10).

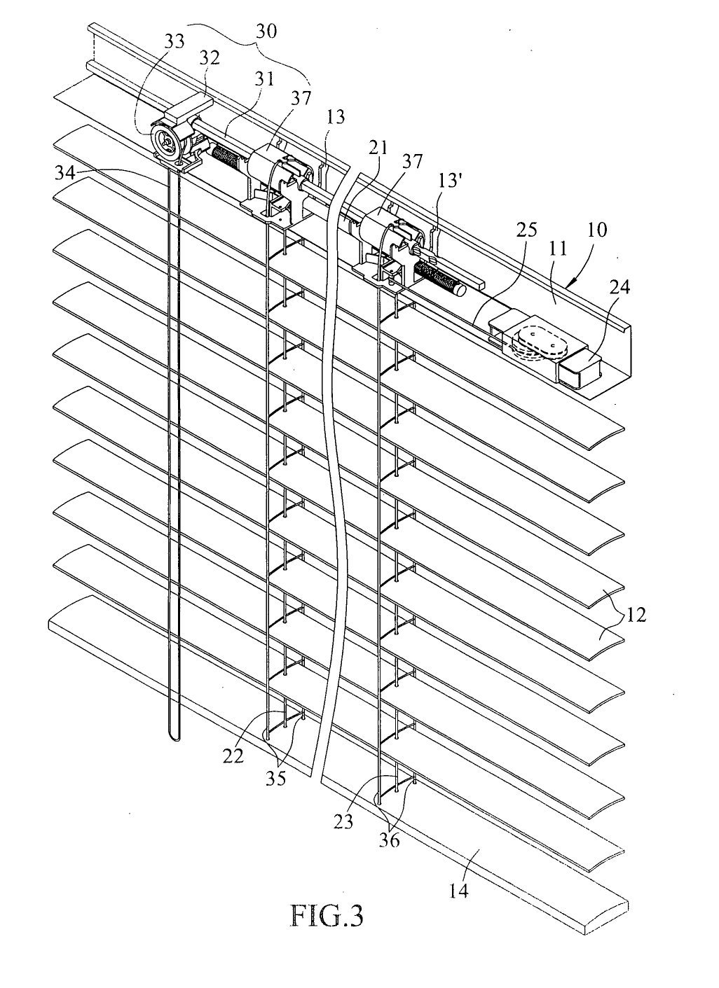

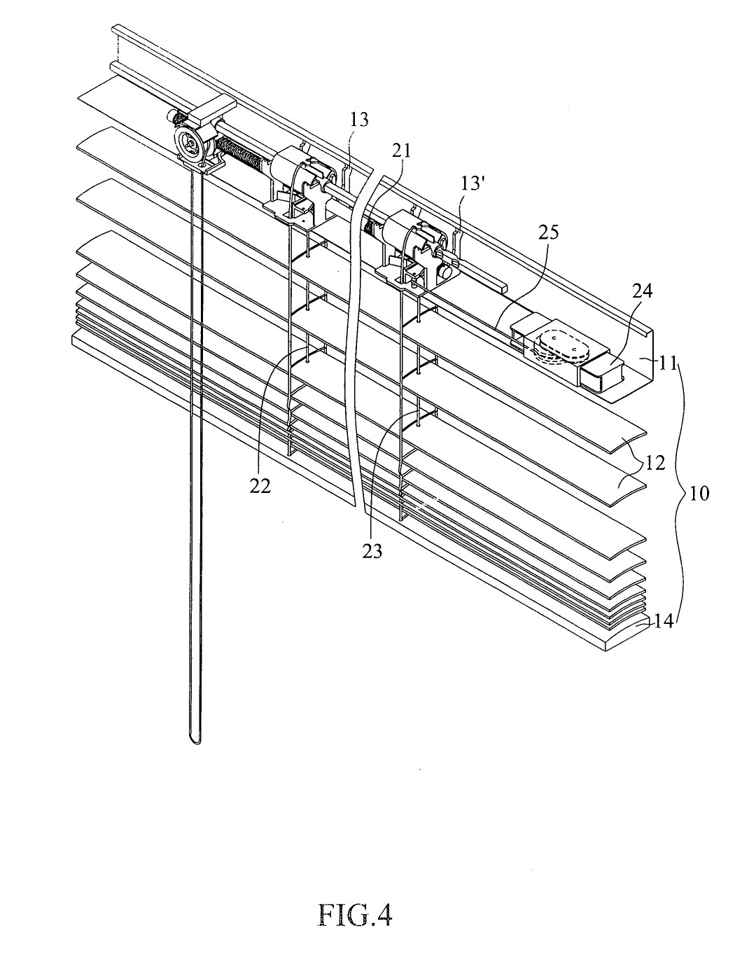

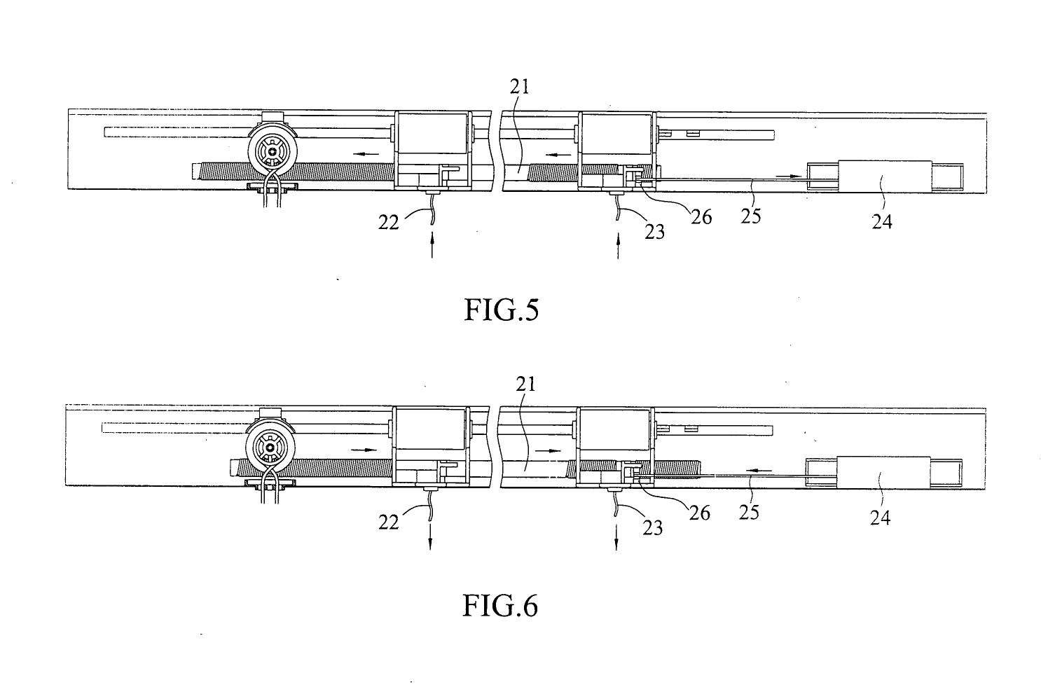

With reference to FIGS. 3 to 6, when adjusting the height of the slats (12), the lower bar (14) with the series of slats (12) is downwardly pulled. In the meantime, the first operating cord (22) and the second operating cord (23) are downwardly pulled to rotate the shaft (21) such that the drive cord (25) is pulled out of the drive device (24) and coiled on the shaft (21), and the spring in the drive device (24) is overly released. In addition, the drive cord (25) is automatically coiled into the drive device (24) and drives the shaft (21) due to the restitution force of the spring in the drive device (24) when the lower bar (14) is continually lifted. In the meantime, the shaft (21) is reversely rotated to coil the first operating cord (22) and the second operating cord (23) to lift the series of slats (12) and the lower bar (14). The shaft (21) is stopped when the slats (12) are adjusted to a suitable height and the lower bar (14) is not forced. Consequently, the operator can easily and conveniently adjusting the height of the slats (12).

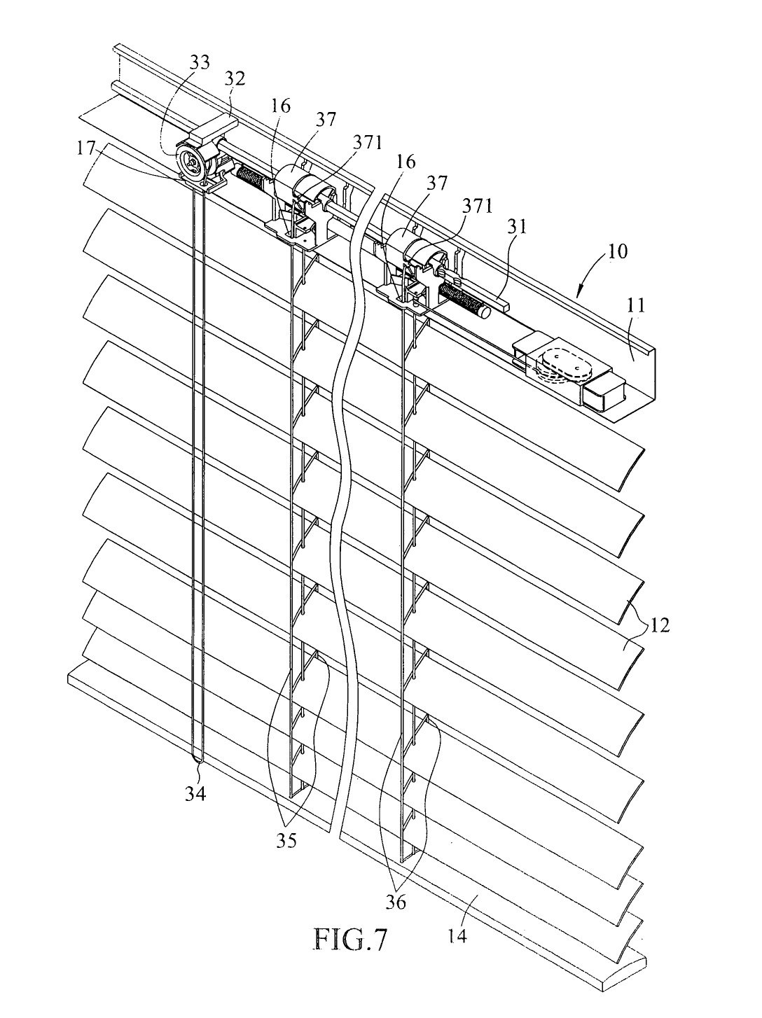

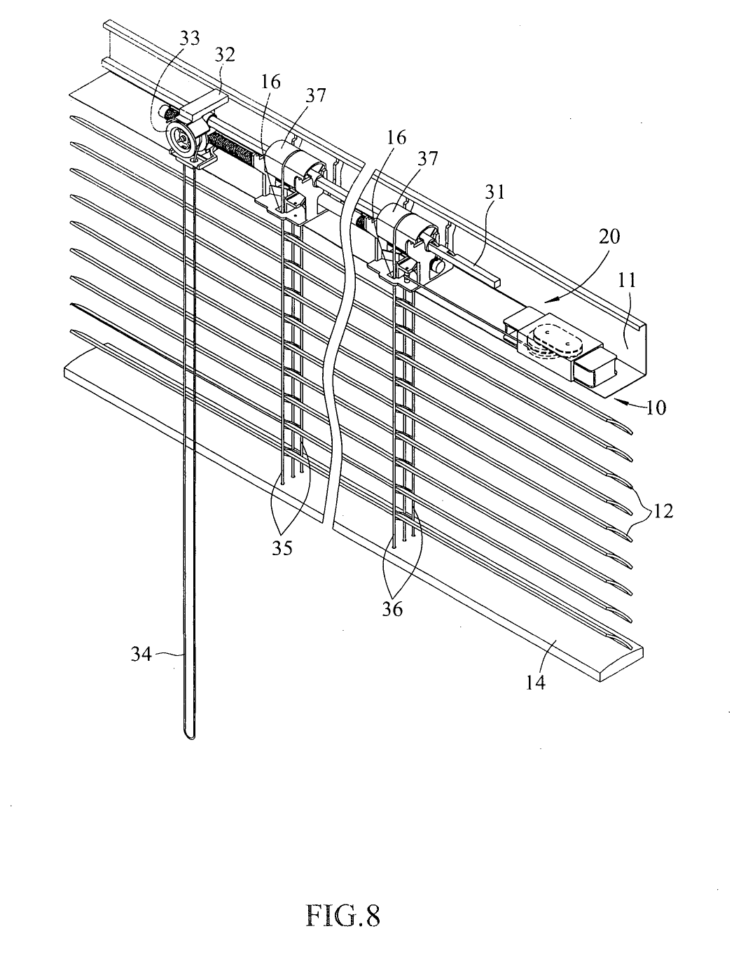

With reference to FIGS. 7 and 8, the wheel (33) is rotated to operate the adjusting device (32) for driving the polygonal shaft (31) when the adjusting rope (34) is downwardly pulled. The polygonal shaft (31) drives the two drive seats (37) to influence the first adjusting cord (35) and the second adjusting cord (36) for simultaneously adjusting the angle of each of the series of slats (12). Consequently, the structure of the adjusting device (30) is simplified and the manufacturing cost is reduced.

Although the invention has been explained in relation to its preferred embodiment, it is to be understood that many other possible modifications and variations can be made without departing from the spirit and scope of the invention as hereinafter claimed.

What is claimed is:

1. A window blinds comprising:
a head box having a chamber defined therein and a series of slats connected under the head box;
an operating system received in the chamber in the head box, the operating system having a shaft rotatably and movably disposed in the head box, a first operating cord and a second operating cord respectively having a first end coiled on the shaft and a second end sequentially extending through a bottom of the head box and the series of slats, a drive device with a spring mounted in the head box, a drive cord having a first end coiled on the shaft and a second end connected to the spring for driving the shaft; and
an adjusting device mounted in the head box, the adjusting device including an adjusting driver mounted in the head box opposite to the drive device and a polygonal shaft with one end connected to the adjusting driver, a first adjusting cord having a middle portion connected to the polygonal shaft and two opposite ends respectively extending through the bottom of the head box and sequentially connected to two opposite sides of each of the series of slats for adjusting an angle of each of the series of slats when the polygonal shaft is rotated, a second adjusting cord having a middle portion connected to the polygonal shaft and two opposite ends respectively extending through the bottom of the head box and sequentially connected to two opposite sides of each of the series of slats for adjusting an angle of each of the series of slats when the polygonal shaft is rotated, the adjusting device having a wheel laterally mounted thereon, an adjusting rope wound the wheel and extending through the bottom of the head box for user to operate the adjusting drive for rotating the polygonal shaft.

2. The window blinds as claimed in claim 1, wherein the head box comprises a first frame and a second frame respectively mounted to the bottom of the head box in interval for supporting the shaft and the polygonal shaft, the second frame located near the drive device, the shaft rotatably and movably extending a lower portion of the first frame and the second frame, the polygonal shaft rotatably extending through a top portion of the first frame and the second frame.

3. The window blinds as claimed in claim 2, wherein the second frame has a roller mounted thereon and the drive cord coiled the roller for a smoothly operation.

4. The window blinds as claimed in claim 2, wherein the adjusting device has two drive seats respectively rotatably mounted on the top portion of a corresponding one of the first frame and the second frame, the polygonal shaft extending through the two drive seats for driving the two drive seats, each drive seat having a stopper formed thereon for fixing the first adjusting cord and the second adjusting cord.

5. The window blinds as claimed in claim 1 further comprising
a lower bar connected to the first operating cord, the second operating
cord, the first adjusting cord and the second adjusting cord, the lower bar used as a lowest slat for user to raise/lower the slats.

6. The window blinds as claimed in claim 1, wherein the polygonal shaft extends through two drive seats for driving the two drive seats, each drive seat having a stopper formed thereon for fixing the first adjusting cord and the second adjusting cord.

7. The window blinds as claimed in claim 1, wherein the head box has two first through hole defined in the bottom thereof to allow the first operating cord and the second operating cord extending through the head box.

8. The window blinds as claimed in claim 1, wherein the head box has multiple second through hole defined in the bottom thereof to allow the opposite ends of the first adjusting cord and the second adjusting cord extending through the head box.

9. The window blinds as claimed in claim 1, wherein the head box has a third through hole defined in the bottom thereof to allow the adjusting rope extending through the head box.
